(19) United States
(12) Patent Application Publication
(10) Pub. No.: US 2026/0018152 A1
(43) Pub. Date: Jan. 15, 2026

(54) MEDICAL DEVICE WITH PROTECTIVE AND SOUND-PROOF CASING

(71) Applicant: Justin Kyle Szilagyi, Port Coquitlam (CA)

(72) Inventor: Justin Kyle Szilagyi, Port Coquitlam (CA)

(21) Appl. No.: 19/022,946

(22) Filed: Jan. 15, 2025

(51) Int. Cl. G10K 11/16

(52) U.S. Cl. CPC G10K 11/16

(57) ABSTRACT

A device with sound-proofing casing suitable for persons with hearing implements, head trauma, concussions, or autism. This may be used as a medical device to assist with ingestion. The device is adapted to attach the casing to a body having an outer surface exposed to an environment and an inner surface disposed opposite to the outer surface and configured to snugly engage with each other. The casing may be made of silicone. The device's casing reduces irritating sounds produced during normal use and protects against damage.

### FIELD OF THE INVENTION

The present invention relates to devices and adaptations suitable for people with medical conditions, such as head trauma or autism, in order to protect and reduce noise during their use.

### BACKGROUND OF THE INVENTION

As people are sharing smaller living spaces (such as roommates, families, etc.) there is an issue with unwanted and often highly irritating noise from the use of dishware/cookware in food preparation, serving, eating and cleanup. This noise may be compounded and more troublesome for those wishing to sleep or rest, or for those homes having infants and small children. The noise from dishware has been coined a term called “noisy dishes irritant syndrome” in various literature. While non-hearing-impaired people are greatly affected, those with hearing instrument users are also irritated by these sounds.

In fact, the clatter of dishes and silverware is frequently cited in professional literature as a source of annoyance for hearing instrument users (for example, those with hearing aids). Studies using a digital oscilloscope connected to a Sound Level Meter (“SLM”) revealed that the instantaneous peaks produced during meal preparation and dish-handling activities usually exceeded 80 dB and frequently reached 90 dB in a breakfast nook area-nine feet from the main cooking area.

When the SLM was right by the kitchen sink, many peaks exceeded 100 dBA. One study illustrated that the sound of a dinner plate being placed on another plate at its the highest peak extended to about 103 dB and had a broader peak of 30 ms duration at 101 dB before decaying. The entire sound lasted about 130 ms.

Accordingly, a need exists for a sound-proofing dishware. Other objects of the invention will be apparent from the description that follows.

### SUMMARY OF THE INVENTION

In one aspect, there is provided a medical device comprising: a body; and casing having a sound attenuating mat contacting a topside of the body and configured to snugly engage with a perimeter of the body.

In another aspect the present invention provides a protective and sound-proofing casing adapted to attach to dishware. The casing includes an outer surface exposed to an environment and an inner surface disposed opposite to the outer surface and configured to snugly engage with a portion of the dishware. The inner surface of the protective and sound-proofing casing could be configured to fixedly engage with the dishware. The inner surface of the protective and sound-proofing casing could be configured to fixedly engage with the dishware via an adhesive. The inner surface of the protective and sound-proofing casing could be configured to releasably engage with the dishware. The inner surface of the protective and sound-proofing casing could be configured to a dimension of the dishware and the dimension could be a thickness of the dishware. The inner surface of the protective and sound-proofing casing could be configured to engage with an underside of the dishware. The inner surface of the protective and sound-proofing casing could be configured to engage with a topside of the dishware. The inner surface of the protective and sound-proofing casing could be configured to engage with a perimeter of the dishware. The casing of the protective and sound-proofing casing could be comprised of a dishwasher safe material. The casing of the protective and sound-proofing casing could be comprised of a cushioning material. The casing of the protective and sound-proofing casing could be comprised of a material selected from the group consisting of foams, gels, and polymers. The casing of the protective and sound-proofing casing could be comprised of food grade silicone.

In another aspect, the present invention provides a protected and sound-proof dishware which includes a dishware body, and a sound-proofing casing attached to the dishware. The casing may include an outer surface exposed to an environment and an inner surface disposed opposite to the outer surface and configured to snugly engage with a portion of the dishware body. The inner surface of the protected and sound-proof dishware could be configured to fixedly engage with the dishware body. The inner surface of the protected and sound-proof dishware could be configured to fixedly engage with the dishware body via an adhesive. The inner surface of the protected and sound-proof dishware could be configured to releasably engage with the dishware body. The inner surface of the protected and sound-proof dishware could be configured to a dimension of the dishware body and the dimension could be a thickness of the dishware body. The inner surface of the protected and sound-proof dishware could be configured to engage with an underside of the dishware body. The inner surface of the protected and sound-proof dishware could be configured to engage with a topside of the dishware body. The inner surface of the protected and sound-proof dishware could be configured to engage with a perimeter of the dishware body. The casing of the protected and sound-proof dishware could be comprised of a dishwasher safe material. The casing of the protected and sound-proof dishware could be comprised of a cushioning material. The casing of the protected and sound-proof dishware could be comprised of a material selected from the group consisting of foams, gels, and polymers. The casing of the protected and sound-proof dishware could be comprised of food-grade silicone.

It is an object of the present invention to provide easy adaptations to existing dishware to provide sound attenuating and/or noise reduction properties and in the alternative to provide novel dishware with inherent and integral sound attenuating and/or noise reduction features, when such dishware is in use.

It is one object of the present invention to provide a removable or permanent retrofit for existing dishware which provides sound attenuating and/or noise reduction properties, when such dishware is in use.

It is an object of the present invention to enable the continued use of chosen dishware with adaptations thereon, which adaptations offer sound attenuating and/or noise reduction properties such that use of the dishware and such dishware engaging with other surfaces does not disturb others in proximity.

Other aspects of the invention will be appreciated by reference to the detailed description of the preferred embodiment and to the claims that follow.

### BRIEF DESCRIPTION OF THE DRAWINGS

The preferred embodiment of the invention will be described by reference to the drawings thereof in which:

FIG. 1 is a perspective view of one embodiment of protected and sound-proof dishware atop a table;

FIG. 2 is an exploded elevation view of the protected and sound dishware showing various embodiments of casings;

FIG. 3 is a cross-sectional perspective view of a plurality of plates shown in FIG. 2, taken along line 3-3; and

FIG. 4 is a perspective view of a bowl, a cup, a plate, a fork and knife, each with the protective and sound-proofing casings.

FIG. 5 is a perspective view of a plate with the protective eating mat and bottom ring.

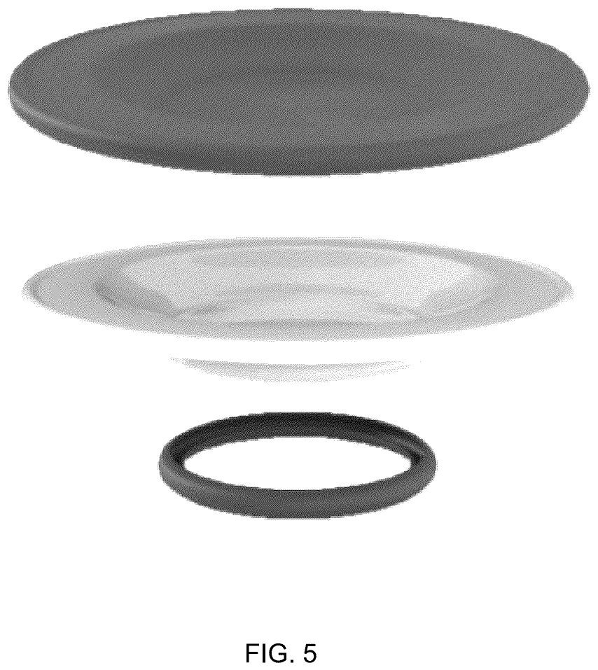

FIG. 6 is a perspective view of a bowl with the protective eating mat and bottom ring.

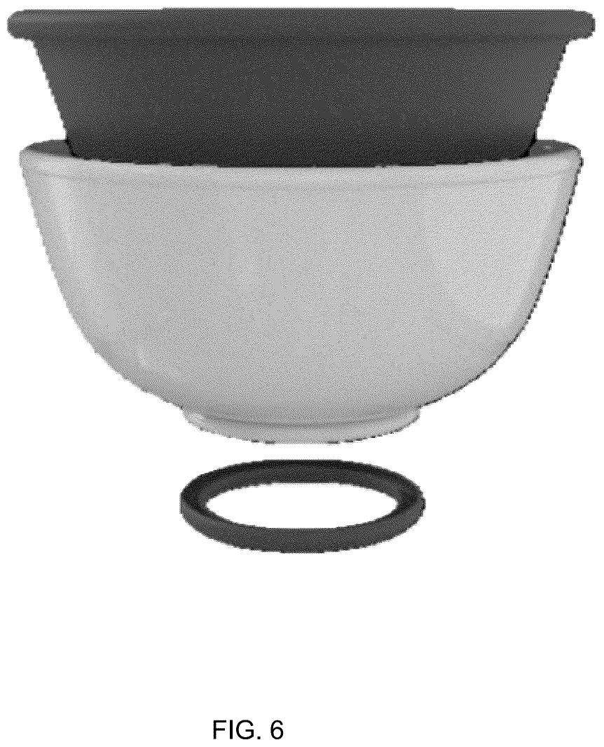

### DESCRIPTION OF THE PREFERRED EMBODIMENTS

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

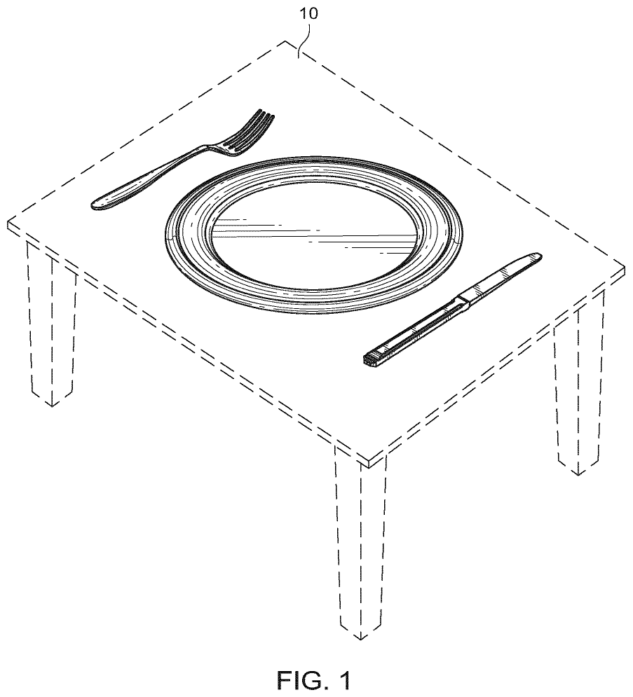

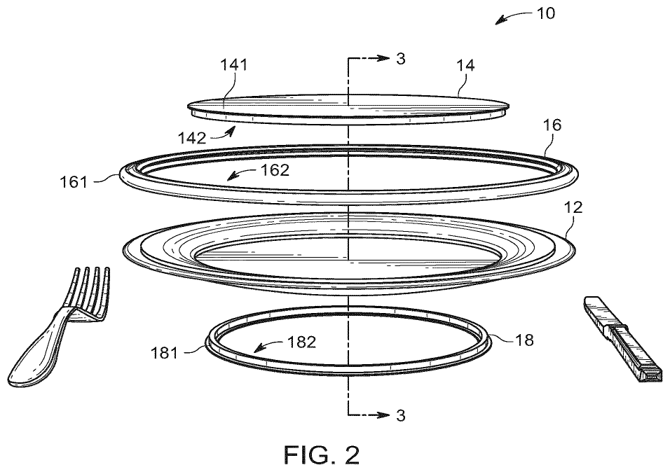

Referring to FIG. 1, the protected and sound-proof dishware according to a first embodiment of the invention is shown generally at 10. Referring to FIG. 2, the dishware 10 includes a plate 12, a silent eating pad 14, an outer bumper 16 and a bottom bumper 18. The silent eating pad 14, the outer bumper 16 and the bottom bumper 18 are embodiments of the protective and sound-proofing casing adapted to attach to plate 12. Each of them includes an outer surface (e.g. 141, 161, 181) exposed to an environment and an inner surface (e.g. 142, 162, 182) disposed opposite to the outer surface (e.g. 141, 161, 181). The inner surface (e.g. 142, 162, 182) snugly engages with a portion of the plate 12.

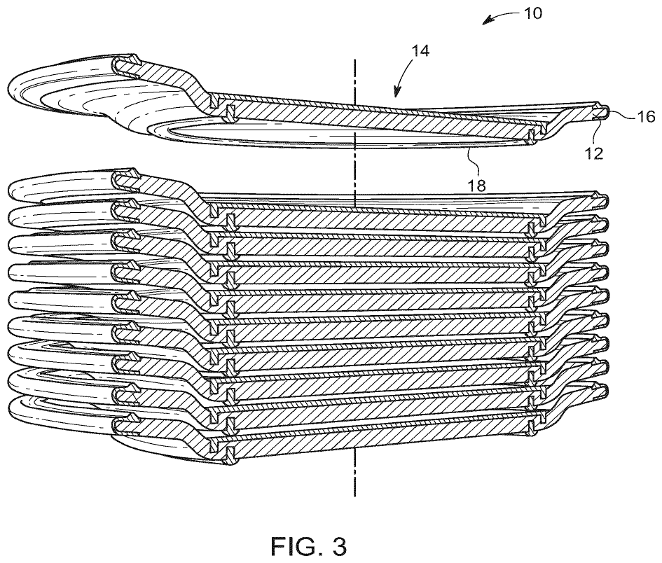

Also referring to FIG. 3, the protective and sound-proofing casings, such as silent eating pad 14, the outer bumper 16 and the bottom bumper 18, snugly engage with or interface with a portion of the plate 12 at its inner surface.

Generally, the present invention comprises, in one aspect, protective and sound proofing casings or noise reduction barrier pieces, which is retro-attachable to any part of existing dishware, and which dampens sound created by the dishware engaging with another “independent surface”. Such independent surface may be, for example, another piece of dishware or cookware, a countertop, a cupboard, a stovetop and the like.

Within the scope of the invention, a user can easily attach one or more protective and sound-proofing casings or noise reduction barrier pieces to any part of any existing dishware in a variety of conformations, all customizable to the particular item of dishware and the degree of noise reduction desired. As a result, the inner surface (e.g. 142, 162, 182 shown in FIG. 2) could releasably engage with the dishware (e.g. plate 12). As described further below, a protective and sound proofing casing or noise reduction barrier piece may be of various materials, shapes, sizes and thicknesses.

Generally, the present invention comprises, in another aspect, dishware which comprises one or more fully or partially integrated or associated protective and sound-proofing casings or noise reduction barrier pieces. In this aspect, a user's existing dishware is not retrofitted with one or more noise reduction barrier pieces, but instead, a user may purchase dishware already comprising such pieces permanently (via an adhesive, for example) or removably associated therewith. As a result, the inner surface (e.g. 142, 162, 182 shown in FIG. 2) could fixedly engage with the dishware (e.g. plate 12). More specifically, dishware is provided which is fully or partially integrated with one or more protective and sound-proofing casings or noise reduction barrier pieces.

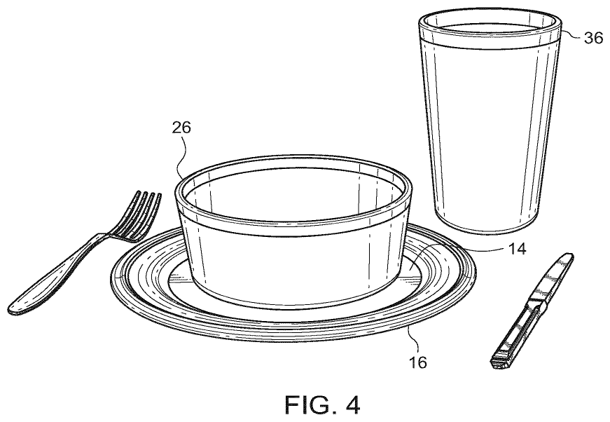

More specifically, one or more protective and sound-proofing casings or noise reduction barrier pieces are disposed on any region (engaging portions) of the dishware. These regions include the underside or lower region of dishware, or perimeter of the dishware, most often being the non-functional face of the dishwasher, with respect to food use, serving and preparation. These regions also include the topside of the dishware, most often being functional face of the dishwasher. Referring to FIG. 2 and FIG. 4, the inner face of the protective and sound-proofing casing (e.g. silent eating pad 14) could engage with the topside of the dishware. The inner face of the protective and sound-proofing casing (e.g. the outer bumper 16, 26, 36) could engage with the perimeter of the dishware. The inner face of the protective and sound-proofing casing (e.g. the bottom bumper 18) could also engage with the underside of the dishware.

The embodiments in this application finally correct the underlying and long frustrating problem of noisy dishes irritant syndrome and its various manifestations. A user can use the noise reduction barrier piece(s) to adapt existing dishware, whether it be everyday dishes or even cherished china, in order to increase its functionality in today's smaller, more closed spaces.

Likewise, a user can acquire already adapted dishware, integrated with one or more noise reduction barrier pieces. Both types of dishware may be referred to herein as “dishware comprising one or more noise reduction barrier pieces” or “dishware of the invention”.

The reasons for using the dishware of the invention, and its benefits, are multi fold. Small living spaces are increasingly popular and in fact are often the only accommodation available in large urban center, even for families. Student housing is often highly tight on space. Micro houses and camper/van living are experiencing a massive surge in popularity and acceptance. FIG. 3 shows the assembly of the plates.

In any of these living arrangements, reducing traditional kitchen noise made by use of banging dishware and utensils is highly desirable for the physical and mental well-being of all occupants. Furthermore, for many individuals, keeping ambient noise at bay is not just a convenience but a health imperative. These include persons with hearing implements, those with head trauma and concussions (post-concussion syndrome), Tourette's, Autism, and other noise sensitivity disorders. The dishware of the invention overcomes these obstacles and problems, using a simple, customizable, inexpensive and elegant solution.

In a most preferred form, the protective and sound-proofing casings or noise reduction barrier piece are customized to the piece of dishware (for example, in FIG. 4, the forks and knives may require specific shapes). Noise reduction barrier pieces may be ring-shaped, in round dots, in strips, in squares, in pads, in elongate tube-like structures etc. For example, for use on the underside of plates, it is preferred (although not required) that the noise reduction barrier piece may be dimensioned to generally conform to the curvature of an edge or perimeter of an underside of the plate.

The protective and sound-proofing casing or noise reduction barrier pieces may be constructed of a sound reducing or sound absorbing or sound reflecting material or any combination thereof. Preferably, the material is cushioning or dampening. There are a variety of materials presently envisaged for easy use within the scope of the invention. However, it is to be understood that there are materials, yet to be discovered, that would also meet the requirements of sound reduction or sound absorption or sound reflection and which are adaptable for use on dishware, as described herein. Such future materials are to be considered as fully usable within the scope of the invention.

Suitable materials may include, but are not limited to, fabrics (e.g., woven, non woven, knits, or other suitable fabrics), foams (e.g., open-celled and closed celled foams, melamine foam, and other suitable foams), gels (e.g., aerogels, hydrogels, and other suitable gels), polymers (e.g., polysiloxanes, polyacrylates, polyam ides, olyarylenes, polycarbonates, polycyanurates, polyesters, polyethylene, polyimides, polypropylene, polystyrene, polysulfones, polyureas, polyurethane, rubber, vinyl, and other suitable polymers), other suitable sound attenuating materials, and mixtures of two or more of any of the foregoing. If foam is used as the noise reduction barrier piece, it may be coated for treated for water resistance.

Most preferred materials for the noise reduction barrier piece are polysiloxanes (for example silicone), foams, elastomers, rubbers and any other material that is flexible, heat resistant and/or flame resistant. More preferably it is preferred that the noise reduction barrier piece is dishwasher safe. As used herein, the term “dishwasher-safe” is understood to mean that any color, text, image, or combination thereof imparted to the material will not wear off or wash off to any appreciable degree as a result of cycling the material through a dishwasher.

Most preferred as a material is silicone (silicone rubber) in particular as it may be food-grade, BPA-free, Lead-free, PVC-free and Phthalate-free. It is chemically inert and stable, so it is unlikely to react with or leach into food, nor outgas vapors.

In addition, silicone is easy to clean, can be safely boiled to sterilize and can be cleaned in the dishwasher and does not warp or damage under prolonged exposure to both hot and cold temperatures. Moreover, it is microwave, freezer and dishwasher safe.

The thickness of the protective and sound-proofing casing or noise reduction barrier piece can vary in accordance with particular dishware and usages. Generally, it is preferred that the thickness is on the order of about 1-3 mm, more preferably around 2 mm (uncompressed), although other thicknesses can advantageously be used. For example, a large serving platter, which is likely to hold a heavy turkey or other large food items may comprise one or more noise reduction barrier pieces which exceed the thickness of pieces on a small side plate.

The protective and sound-proofing casing or noise reduction barrier piece may be attached to the underside of by using a semi-permanent or permanent adhesive, although other means of attachment can be used. In some embodiments, it is desired that the attachment of the protective and sound proofing casing or noise reduction barrier piece to a dishware piece is more easily removable and in other instances, a more permanent attachment is desired.

Selecting appropriate adhesives for the desired outcomes is within the purview of a person skilled in the art. In some instances, it is desired that the noise reduction barrier piece may be fully or partially integral with the dishware.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

The invention is susceptible to many variations, including scaling for capacity, in so long as design and process parameters are maintained. Accordingly, the drawings and following description of the preferred embodiments are to be regarded as illustrative in nature, and not as restrictive.

The term “product” means any machine, manufacture and/or composition of matter, unless expressly specified otherwise.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” or “variant” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represents” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number, and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “respective” and like terms mean “taken individually”. Thus, if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

This description of preferred embodiments is to be read in connection with the accompanying drawings, which are part of the entire written description of this invention. In the description, corresponding reference numbers are used throughout to identify the same or functionally similar elements. Relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship.

Any given numerical range shall include whole and fractions of numbers within the range. For example, the range “1 to 1 O” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage
of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). The title of the present application and headings of sections provided in the present application are for convenience only and are not to be taken as limiting the disclosure in any way.

1. A medical device comprising:
a body; and
casing having a sound attenuating mat contacting a topside of the body and configured to snugly engage with a perimeter of the body.

2. The medical device of claim 1, wherein said mat has a protrusion that fixedly engages with a groove in the topside of the body.

3. The medical device of claim 1, wherein said casing is fixedly engaged with the body via an adhesive.

4. The medical device of claim 1, wherein said casing is releasably engaged with the body.

5. The medical device of claim 1, wherein the body is shaped to be stackable with additional same bodies and wherein the casing is located on the body to contact the additional same bodies when stacking.

6. The medical device of claim 1, wherein a thickness of the casing is 1-3 mm.

7. The medical device of claim 1, wherein said casing further comprises a sound attenuating bottom bumper having an inner surface engaged with a curvature of an edge on an underside of the body.

8. The medical device of claim 1, said casing further comprises a sound attenuating bottom bumper snugly engaged into a groove in an underside of the body.

9. The medical device of claim 1, wherein the casing is comprised of a cushioning material.

10. The medical device of claim 1, wherein the casing is comprised of a material selected from the group consisting of foams, gels, silicone and polymers.
